(19) United States
(12) Patent Application Publication
(10) Pub. No.: US 2003/0036296 A1
(43) Pub. Date: Feb. 20, 2003

(54) Method for attaching a connector to a printed circuit board of a disc drive

(75) Inventors: Alvin E. Cox, Yukon, OK (US); Gary P. Oldham, Choctaw, OK (US)

Correspondence Address: FELLERS, SNIDER, BLANKENSHIP, BAILEY & TIPPENS. PC, BANK ONE TOWER, 100 NORTH BROADWAY, SUITE 1700, OKLAHOMA CITY, OK, 73102-0621, US

(73) Assignee: Seagate Technology LLC, Scotts Valley, CA

(21) Appl. No.: 10/126,806

(22) Filed: Apr. 18, 2002

Related U.S. Application Data
(60) Provisional application No. 60/313,617, filed on Aug. 20, 2001.

(51) Int. Cl. H01R 4/66; H01R 13/648

(52) U.S. Cl. 439/108

(57) ABSTRACT

A method is provided for attaching a connector with connector tails to a printed circuit board (PCB) having contacts. The method includes steps of: supplying and supporting the PCB; applying solder paste to the PCB contacts; inserting mounting hardware through the connector holes; presenting the connector to the PCB in a position above and parallel to the PCB; lowering the connector to align the mounting hardware with PCB orifices; pressingly engaging the connector tails against the PCB contacts to make the connector tails coplanar; tightening the mounting hardware to secure the connector to the PCB; and soldering the connector tails to the PCB contacts. In one embodiment, the mounting hardware is a rivet. In another embodiment, the mounting hardware is a nut and bolt. In yet another embodiment, the mounting hardware is electrically non-conductive.

### RELATED APPLICATIONS

This application claims the benefit of U.S. Provisional Application No. 60/313,617 entitled SCA-2 SINGLE SIDED CONNECTOR FOR AUTOMATED PLACEMENT filed Aug. 20, 2001.

### FIELD OF THE INVENTION

The claimed invention relates generally to disc drive data storage devices and more particularly to methods for attaching connectors to printed circuit boards for disc drives.

### BACKGROUND OF THE INVENTION

Data storage devices of the type known as “Winchester” disc drives are well known in the industry. These disc drives magnetically record digital data on several circular, concentric data tracks on the surfaces of one or more rigid discs. The discs are typically mounted for rotation on the hub of a spindle motor. The spindle motor is mounted to a base deck. In disc drives of the current generation, the discs are rotated at speeds of more than 10,000 revolutions per minute.

Data are recorded to and retrieved from the discs by an array of vertically aligned read/write head assemblies, or heads, which are controllably positioned by an actuator assembly. Each head typically includes electromagnetic transducer read and write elements which are carried on an air bearing slider. The slider acts in a cooperative hydrodynamic relationship with a thin layer of air dragged along by the spinning discs to fly each head in a closely spaced relationship to the disc surface. In order to maintain the proper flying relationship between the heads and the discs, the heads are attached to and supported by flexures (also called head suspensions).

A disc drive printed circuit board (PCB) receives commands from a host computer to perform a read or write operation, sends signals to the disc drive to perform the operation, and sends back to the host computer information read from the disc drive. To facilitate these operations, a connector connects a cable or backplane printed circuit board carrying several wires to the PCB. The backplane printed circuit board and the connector provide a path between the PCB and the host computer for the transmission of electrical signals.

Several methods are known in the art for attaching the connector to the PCB. However, these attachment methods have drawbacks when performed in a high-volume automated environment. For example, some of these methods result in solder paste being “bulldozed” and shorting across contacts on the PCB. Another problem with existing attachment methods is that attachment hardware use a snapping action to seat a clip into place, which may cause misalignment of other electrical components on the PCB or misalignment of the connector with respect to the PCB. Yet another problem is that connector tails become non-coplanar due to handling or manufacturing variations. This may also result in misalignment of the connector tails with the contacts on the PCB.

Another problem with electrical connectors of the existing art is that some of these electrical connectors rely on the mounting hardware to be electrically conductive to provide a grounding path from a backplane printed circuit board to the disc drive PCB. Using electrically conductive mounting hardware can cause an electrical short to equipment surrounding the electrical connector.

It is to these and other problems of the existing art that the present embodiments are directed.

### SUMMARY OF THE INVENTION

A connector is provided for a disc drive PCB. The connector has a male plug with a housing for receiving the female end of a backplane receptacle connector. Connector tails contact electrical contacts on the PCB to make the electrical connection between a host computer and the PCB. The connector tails are thin conductive metal wires that extend from the plug. The connector tails are soldered to the PCB. The connector is secured to the PCB by rivets which fit through holes defined in the connector and orifices on the PCB. A rivet tool applies pressure to compress each rivet, causing the lower portion to flatten against a bottom side of the PCB. Each rivet head contacts a top side of the connector. In another preferred embodiment, the rivets are replaced by nuts and bolts as mounting hardware.

The connector also has a pair of advanced ground contacts (AGCs) disposed on opposite sides of the connector. In one embodiment, the AGCs engage conductive pads disposed about the connector holes. The AGCs attach to ground wires on the backplane printed circuit board. The mounting hardware contacts the conductive pads on the top side of the connector. The connector also has a pair of alignment pegs that mate with orifices on the PCB to assist in aligning the connector for attachment to the PCB.

A method is also provided for attaching a connector with connector tails to contacts on the PCB. The method includes steps of: (a) supplying and supporting the PCB; (b) applying solder paste to the PCB contacts; (c) inserting mounting hardware through connector holes; (d) presenting the connector to the PCB in a position above and parallel to the PCB; (e) lowering the connector to align the mounting hardware with PCB orifices; (f) pressingly engaging the connector tails against the PCB contacts to make the connector tails coplanar; (g) tightening the mounting hardware to secure the connector to the PCB; and (h) soldering the connector tails to the PCB contacts.

These and various other features as well as advantages which characterize the claimed invention will become apparent upon reading the following detailed description and upon reviewing the associated drawings.

### BRIEF DESCRIPTION OF THE DRAWINGS

FIG. 1 is a plan view of a disc drive constructed in accordance with preferred embodiments of the present invention.

FIG. 2 is a schematic view of connections between a host computer and a disc drive of the existing art.

FIG. 3 is a top view of a disc drive PCB of the existing art.

FIG. 4 is a bottom view of a connector of the existing art.

FIG. 5 is a top view of a connector of the existing art.

FIG. 6 is a side view of a connector of the existing art.

FIG. 7 is a top view of a connector constructed in accordance with preferred embodiments of the present invention.

FIG. 8 is a bottom view of a connector constructed in accordance with preferred embodiments of the present invention.

FIG. 9 is a side view of a connector constructed in accordance with preferred embodiments of the present invention.

FIG. 10 is a plan view of a pop rivet in accordance with preferred embodiments of the present invention.

FIG. 11 is a side view of a connector constructed in accordance with an alternate preferred embodiment of the present invention.

FIG. 12 is a flow chart showing the steps of a method for attaching a connector to a printed circuit board constructed in accordance with preferred embodiments of the present invention.

### DETAILED DESCRIPTION

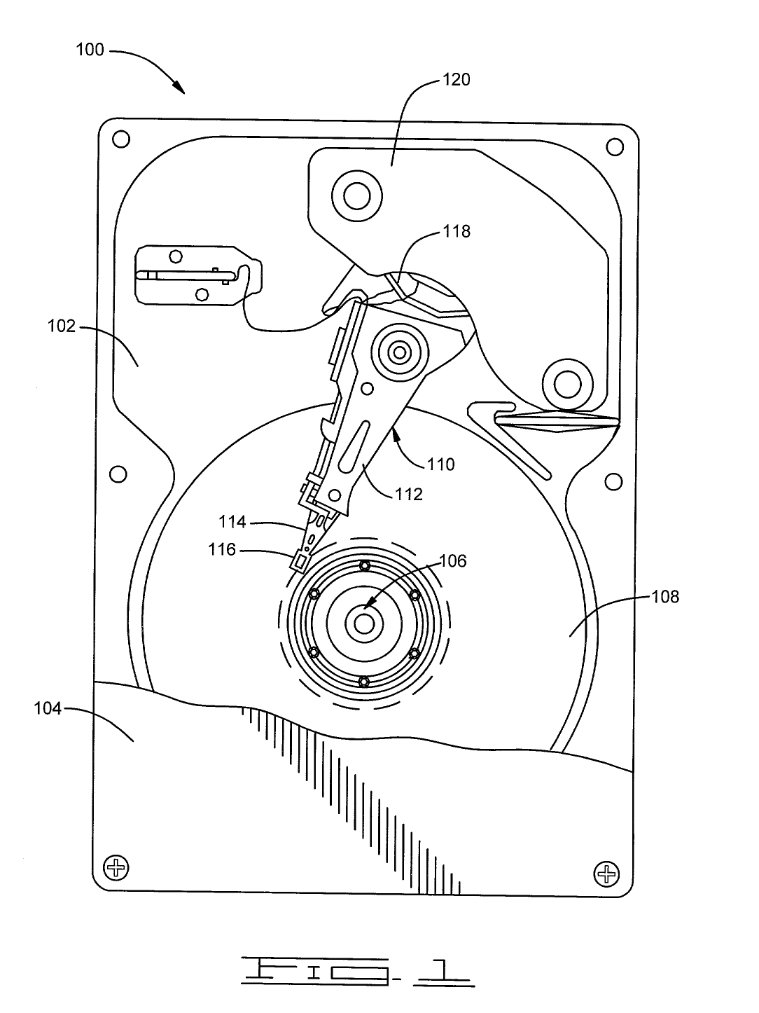

FIG. 1 provides a top plan view of a disc drive 100 constructed in accordance with preferred embodiments of the present invention. A base deck 102 and a top cover 104 (shown in partial cutaway) cooperate to form a sealed housing for the disc drive 100. A spindle motor with a hub 106 rotates a number of magnetic recording discs 108 at a constant, high speed. An actuator assembly 110 includes a number of rigid actuator arms 112 that extend adjacent the disc surfaces. Flexible suspension assemblies (flexures) 114 extend from the arms 112 to support an array of read/write heads 116. The actuator assembly 110 is pivotally moved through the application of current to an actuator coil 118 of a voice coil motor (VCM) 120. The portions of the disc drive 100 shown in FIG. 1 make up a head/disc assembly (HDA) 121.

FIG. 2 shows a schematic representation of the disc drive 100 and the connections between the disc drive 100 and the host computer 122. Typically, the host computer 122 connects to a connector 124 by a backplane printed circuit board 126. A female receptacle of the backplane printed circuit board 126 plugs into the connector 124 in a standard trapezoidal plug receptacle. The connector 124 mechanically attaches to a disc drive printed circuit board (PCB) 128 and the electrical connections between the connector 124 and the PCB 128 are soldered. The PCB 128 connects to the disc drive 100 to provide a communication path between the host computer 122 and the disc drive 100.

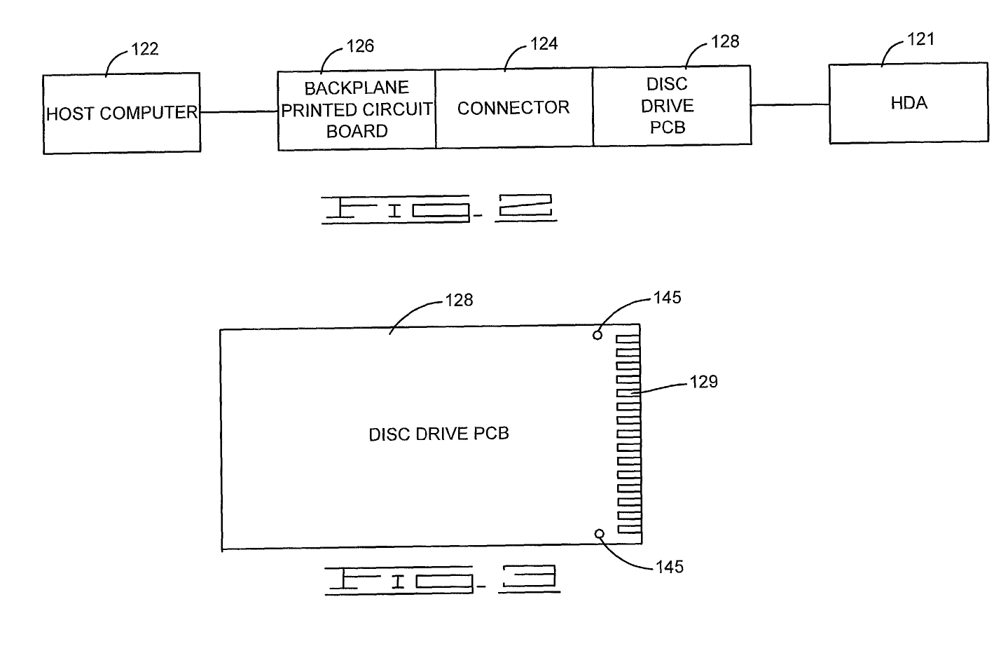

FIG. 3 shows a PCB 128 of the existing art. The PCB 128 has contacts 129 at one end of the PCB 128. The PCB 128 has orifices 145 formed in the PCB 128 for mounting of the connector 124.

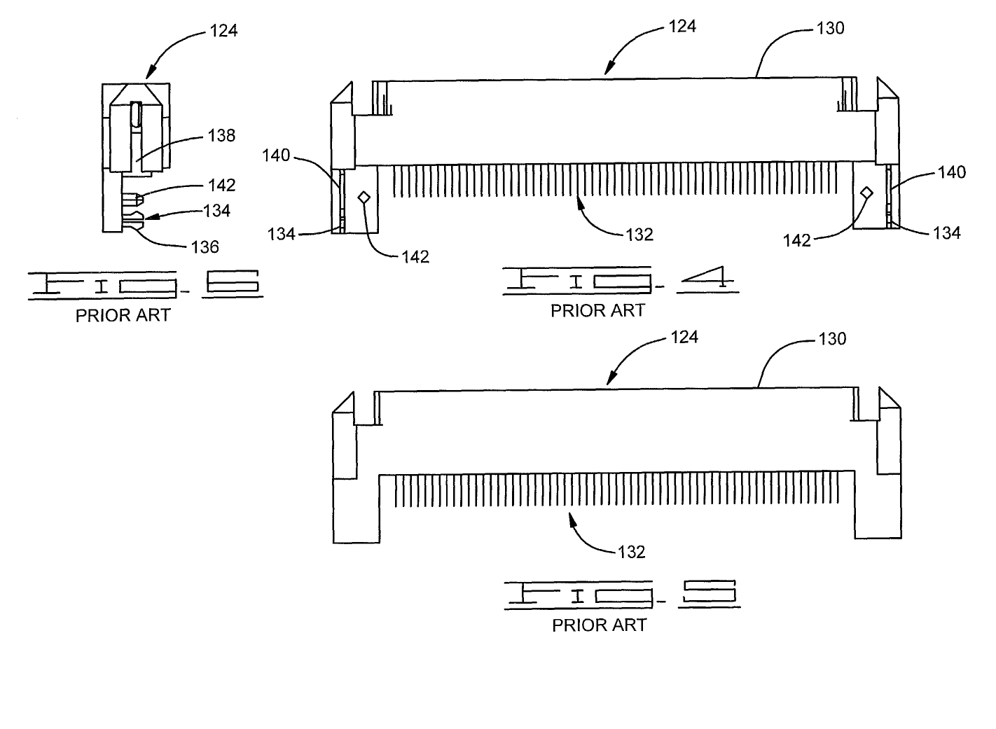

FIGS. 4-6 show a connector 124 of the existing art. The connector 124 has a plug with a receptacle housing 130 for receiving a female backplane connector. Connector tails 132 contact the electrical contacts 129 on the PCB 128 to make the electrical connection between the backplane printed circuit board 126 from the host computer 122 to the PCB 128. The connector tails 132 are thin conductive metal wires that extend from the receptacle housing 130. The connector 124 is secured to the PCB 128 by forcing clips 134 into a cavity on the PCB 128. The clip 134 has a head portion 136 which deflects inwardly when the clip 134 is being forced through the cavity. The head portion 136 expands outwardly when the head portion 136 has passed through the cavity of the PCB 128.

The connector 124 also has a pair of advanced ground contacts (AGCs) 138 disposed on opposite sides of the connector 124. Metal strips 140 provide conductive paths between the AGCs 138 and the clips 134. The AGCs 138 connect to corresponding contacts (not shown) on the female receptacle of the backplane printed circuit board. The clips 134 contact ground connections on the PCB 128 so that conductive paths are provided between the ground wires on the backplane printed circuit board 126 and the ground connections on the PCB 128. The connector 124 also has a pair of alignment pegs 142 that mate with orifices (not shown) on the PCB 128 to assist in aligning the connector 124 for attachment to the PCB 128.

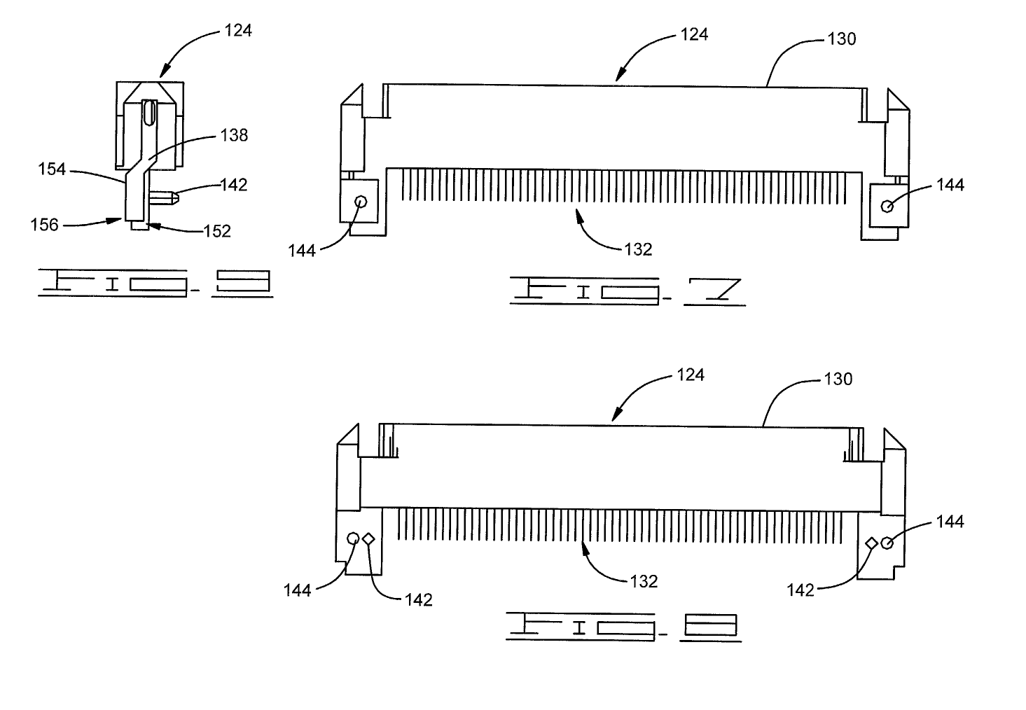

FIGS. 7-9 show different views of a connector 124 constructed and installed in accordance with preferred embodiments of the present invention. The connector 124 has a receptacle with a receptacle housing 130 for receiving a female backplane connector. Connector tails 132 contact the electrical contacts 129 on the PCB 128 to make the electrical connection between the backplane printed circuit board 126 from the host computer 122 to the PCB 128. The connector tails 132 are thin conductive metal wires that extend from the receptacle housing 130. The connector 124 is secured to the PCB 128 by pop rivets (shown in FIG. 10) which fit through holes 144 defined in the connector 124 and orifices 145 defined in the PCB 128.

Referring briefly to FIG. 10, a pop rivet 146 is shown that attaches the connector 124 to the PCB 128. Although the pop rivet 146 is shown in FIG. 10, other mounting hardware such as a nut and bolt or another type of rivet may also be used in place of the pop rivet 146. Each pop rivet 146 has a head 148 and a lower portion 150. To attach the connector 124 to the PCB 128, the rivet lower portion 150 is inserted through the orifice on the PCB 128 and through the hole 144 until the head contacts a top side 156 of the connector 124. A rivet tool (not shown) applies pressure to compress each pop rivet 146, causing the lower portion 150 to flatten against a bottom side of the PCB 128. The head 148 contacts the top side 156 of the connector 124.

The connector 124 also has a pair of AGCs 138 disposed on opposite sides of the connector 124. For the preferred embodiment shown in FIGS. 7-9, the AGCs 138 engage conductive pads 154 disposed about the connector holes 144. Each of the AGCs 138 attaches to a ground wire (not shown) on the backplane printed circuit board 126. The mounting hardware 146 contacts the conductive pads 154 on the top side 156 of the connector 124. For this embodiment, the mounting hardware 146 contacts a ground connection on the PCB 128 to provide a conductive path from the cable 126 to the ground connection on the PCB 128. The connector 124 also has a pair of alignment pegs 142 that mate with orifices 145 on the PCB 128 to assist in aligning the connector 124 for attachment to the PCB 128.

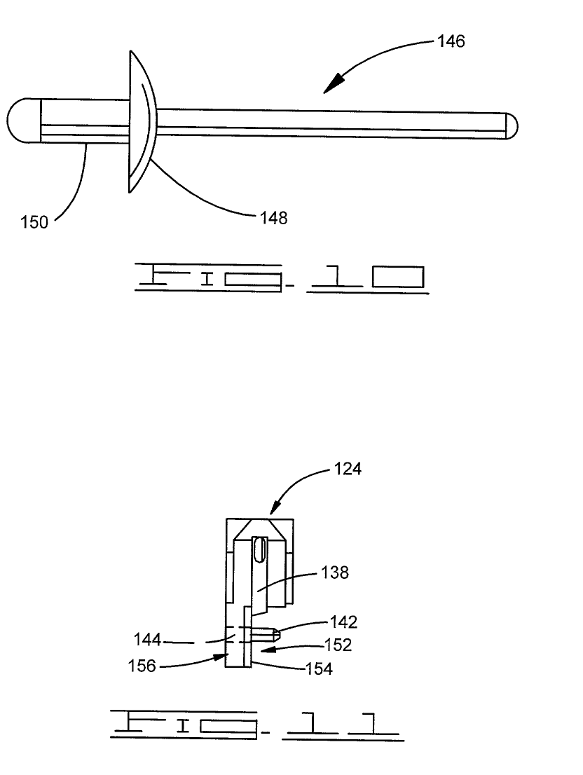

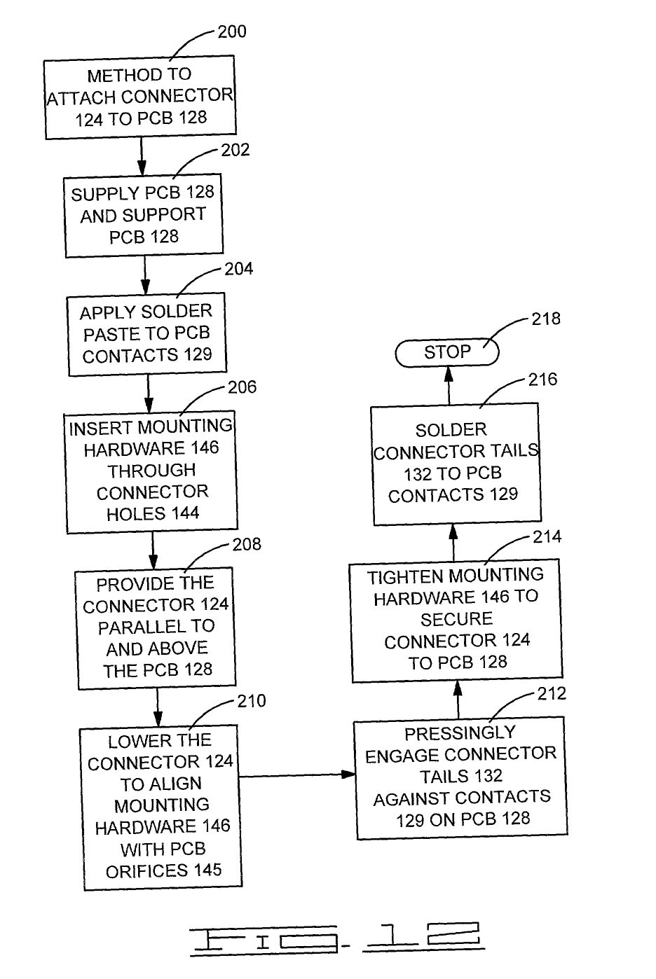

In an alternative preferred embodiment, a side view of which is shown in FIG. 11, the conductive pad 154 is located on the bottom side 152 of the connector 124. The AGCs 138 are captured under the rivet head 148 when the connector 124 is mounted to the PCB 128. The AGCs 138 are in direct contact with a ground connection on the PCB when mounting hardware 146 compresses the connector 124 to the PCB 128. In both embodiments shown in FIGS. 9 and 11, the AGCs 138 have a conductive path to a ground on the PCB 128. However, for the embodiment shown in FIG. 11, the connector 124 does not rely on the mounting hardware 146 to make the electrical ground connection between the backplane printed circuit board 12 and the PCB 128 and, thus, can be electrically non-conductive. Providing electrically non-conductive mounting hardware 146 can be advantageous because electrically conductive mounting hardware can cause an electrical short to equipment surrounding the connector 124. Also, in some applications where weight is critical, the electrically non-conductive hardware is usually lighter than conductive hardware.

FIG. 12 shows a method 200 of mounting the connector 124 to the PCB 128. At step 202, the PCB 128 is supplied and properly supported. At step 204, solder paste is applied to the contacts 129 of the PCB 128. At step 206, the attachment hardware 146 is loaded through the connector holes 144. When the mounting hardware is a nut and bolt, only the bolt portion is loaded through the connector holes in step 206.

At step 208, a special placement head provides the connector 124 to the PCB 128 such that the mounting hardware aligns with the PCB orifices 145. By positioning the connector 124 above and parallel to the PCB 128 and bringing the connector 124 straight down into position at step 210, one prevents the solder paste from being “bulldozed” or forcibly moved from the contacts 129 on the PCB 128.

At step 212, a force is applied to the connector 124 so that the connector tails 132 pressingly engage the PCB 128. This pressing engagement causes the connector tails 132 to be aligned in the same plane. At step 214, the mounting hardware 146 is tightened to secure the connector 124 to the PCB 128. If the mounting hardware is a rivet 146, the rivet 146 is compressed by a rivet tool. If the mounting hardware is a nut and a bolt, the nut is placed on the bolt and rotated on the bolt to tighten the nut. The alignment pegs 142 help to ensure that the connector tails 132 precisely align with contacts 129 on the PCB.

At step 216, the connector tails 132 are soldered to the contacts 129 on the PCB 128. This is typically accomplished by heating the PCB 128 to a temperature sufficient to melt the solder paste. Any additional components to be soldered to the PCB 128 may be placed on the PCB 128 after step 204 and before step 216. At step 218, one has finished the attachment of the connector 124 to the PCB and one stops performing the method.

Accordingly, a connector (such as 124) is provided for a disc drive PCB (such as 128). The connector has a male plug with a housing (such as 130) for receiving the female end of a backplane receptacle connector (such as126). Connector tails (such as 132) contact electrical contacts (such as 129) on the PCB to make the electrical connection between the cable from a host computer (such as 122) to the PCB. The connector tails are thin conductive metal wires that extend from the housing. The connector is secured to the PCB by rivets which fit through holes (such as 144) defined in the connector and orifices (such as 145) on the PCB. A rivet tool applies pressure to compress each rivet 146, causing the lower portion 150 to flatten against a bottom side of the PCB 128. Each rivet head (such as 148) contacts a top side (such as 152) of the connector. The connector also has a pair of AGCs (such as 138) disposed on opposite sides of the connector. In one embodiment, the AGCs contact engage conductive pads (such as 154) disposed about the connector holes. The AGCs attach to ground wires on the backplane connector. The mounting hardware contacts the conductive pads on the top side of the connector. The connector also has a pair of alignment pegs (such as 142) that mate with orifices on the PCB to assist in aligning the connector for attachment to the PCB.

A method (such as 200) is provided for attaching a connector with connector tails to a printed circuit board (PCB) having contacts. The method includes: (a) a step of supplying and supporting the PCB (such as step 202); (b) a step of applying solder paste to the PCB contacts (such as step 204); (d) a step of inserting mounting hardware through the connector holes (such as step 206); (e) providing the connector to the PCB in a position above and parallel to the PCB (such as step 208); (f) a step of lowering the connector to align the mounting hardware with the PCB orifices (such a step 210) (g) a step of pressingly engaging the connector tails against the PCB contacts to make the connector tails coplanar (such as step 212); (g) a step of tightening the mounting hardware to secure the connector to the PCB (such as step 214); and (h) a step of soldering the connector tails to the PCB contacts (such as step 216).

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the electrical connector without departing from the spirit and scope of the present invention.

Many of the claims below include steps for attaching a connector to a PCB. Although the steps are listed in a particular order, this does not mean that the steps must be carried out in the order the steps are listed. The only order that may be inferred from the claims is for the steps that must be accomplished before other steps can be accomplished.

In addition, although the embodiments described herein are directed to an electrical connector for a disc drive, it will be appreciated by those skilled in the art that the connector can be used for other devices without departing from the spirit and scope of the claimed invention.

What is claimed is:

1. A method for attaching a connector with connector tails to a disc drive printed circuit board (PCB) having contacts, the method comprising:
supplying and supporting the PCB;
applying solder paste to the PCB contacts;
inserting mounting hardware through aligned connector holes and PCB orifices;
presenting the connector to the PCB in a position above and parallel to the PCB;
lowering the connector to align the mounting hardware with PCB orifices;
tightening the mounting hardware to secure the connector to the PCB; and
soldering the connector tails to the PCB contacts.

2. The method of claim 1 wherein, prior to tightening the mounting hardware, the method further comprises a step of pressingly engaging the connector tails against the PCB contacts to make the connector tails coplanar.

3. The method of claim 2 wherein the mounting hardware comprises a rivet.

4. The method of claim 2 wherein the mounting hardware comprises a nut and a bolt.

5. The method of claim 4 wherein an advanced around contact (AGC) on the connector is positioned under a head of the bolt when the bolt is inserted in the connector holes.

6. The method of claim 3 wherein an advanced ground contact (AGC) on the connector is positioned under a head of the rivet when the rivet is inserted in the connector holes.

7. A disc drive having a PCB with a connector attached thereto in accordance with the method of claim 1.

8. A printed circuit board assembly comprising a disc drive printed circuit board (PCB) having contacts and a connector formed by a process comprising:
supplying and supporting the PCB;
applying solder paste to the PCB contacts;
inserting mounting hardware through aligned connector holes and PCB orifices;
presenting the connector to the PCB in a position above and parallel to the PCB;
lowering the connector to align the mounting hardware with PCB orifices;
tightening the mounting hardware to secure the connector to the PCB; and
soldering the connector tails to the PCB contacts.

9. The method of claim 8 wherein, prior to tightening the mounting hardware, the process further comprises a step of pressingly engaging the connector tails against the PCB contacts to make the connector tails coplanar.

10. The method of claim 9 wherein the mounting hardware comprises a rivet.

11. The method of claim 9 wherein the mounting hardware comprises a nut and a bolt.

12. The method of claim 10 wherein the mounting hardware is conductive.

13. The method of claim 10 wherein the mounting hardware is nonconductive.

14. The method of claim 10 wherein an advanced ground contact (AGC) on the connector is positioned under a head of the rivet when the rivet is inserted in the connector holes.

15. The method of claim 11 wherein an advanced ground contact (AGC) on the connector is positioned under a head of the bolt when the bolt is inserted in the connector holes.

16. A connector for mounting to a disc drive printed circuit board (PCB), the PCB having orifices formed therein for mounting the electrical connector to the PCB, the connector comprising:
a receptacle with a receptacle housing for receiving a backplane connector, the receptacle having connector holes formed therein;
connector tails attached to and extending from the connector housing;
mounting hardware for fastening the connector to the PCB; and
an advanced ground contact (AGC) providing an electrical grounding path between the PCB and the backplane connector, wherein the AGC directly contacts a ground connection on the PCB.

17. The connector of claim 16 wherein the mounting hardware is electrically non-conductive.

18. The connector of claim 17 wherein the mounting hardware is a rivet.

19. The connector of claim 17 wherein the mounting hardware comprises a nut and bolt.

20. The connector of claim 16 wherein the mounting hardware fits through the connector holes and the PCB orifices and mechanically fastens the connector to the PCB.
